(19) United States
(12) Patent Application Publication
(10) Pub. No.: US 2014/0108179 A1
(43) Pub. Date: Apr. 17, 2014

(54) Incentivizing Purchases at Physical Retailers

(71) Applicant: Google Inc., (US)

(72) Inventors: Guangyu Zhu, Redwood, CA (US); Ping Wu, Saratoga, CA (US)

(73) Assignee: Google Inc., Mountain View, CA (US)

(21) Appl. No.: 13/654,201

(22) Filed: Oct. 17, 2012

(51) Int. Cl. G06Q 30/06; G06Q 30/08

(52) U.S. Cl. 705/26.3; 705/26.1; 705/26.4; 705/26.7

(57) ABSTRACT

Shoppers at physical retailers are incentivized to purchase products from a physical retailer. The user provides a product identifier using a user device. The product identifier is used to identify the product being viewed by the user. Online retailers are queried to obtain online bids to sell the product. An incentive is identified for the user based on the product and the physical retailer. The incentive and an online retailer bid are provided to the user for the user to determine whether to purchase the product at the online retailer bid price or using the incentive. The incentive may be based on location information indicating user device movement. The incentive may require the user to perform an action, such as posting to a social network. A different incentive may be provided to the user if the user is leaving the physical retailer to promote purchase at the physical retailer.

### BACKGROUND

1. Field

This invention relates generally to retail shopping, and more particularly to improving conversion rates of shoppers shopping in physical retail stores.

2. Related Art

Traditional physical retailers place physical products on display where the products can be viewed by customers who are on the premises of the retailers. Due to the costs of operating a physical retailer, the prices of products at physical retailers are sometimes higher than prices offered by online retailers. Physical retailers thus face the issue of users investigating a purchase at a physical retailer, but purchasing the product at an online retailer.

Customers visiting a physical retailer may decide to purchase the product from an online retailer for a variety of reasons. For example, a customer may assume that the online retailer offers a lower price than the physical retailer. Likewise, the customer may assume that the online retailer offers a better selection than the physical retailer. The customer may exit the premises of the physical retailer without purchasing the product in order to investigate these issues. Once the customer has left the premises, the customer might find it easier to purchase the product from an online retailer even if the physical retailer offers the product on competitive terms with the online retailer.

### SUMMARY

A computer-implemented method, system, and computer-readable medium incentivizes a purchase at a physical retailer. A purchase incentive request is received from a user device located on the premises of the physical retailer, the purchase incentive request identifying a product for which an incentive is requested by a user. An online retailer bid offering to sell the identified product to the user is obtained from at least one online retailer. An incentive for the user to purchase the identified product offered by the physical retailer is identified. The online retailer bid and the incentive are provided to the user device.

### BRIEF DESCRIPTION OF THE DRAWINGS

FIG. 1 illustrates one embodiment of an environment for providing competitive pricing for product offered at a physical retailer.

FIG. 2 is a high-level block diagram of a computer for acting as a user device, product incentive system, or online retailer according to one embodiment.

FIG. 3 illustrates modules within the product incentive module of the product incentive system according to an embodiment.

FIG. 4 is a flowchart illustrating a method for incentivizing purchases at physical retailers according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

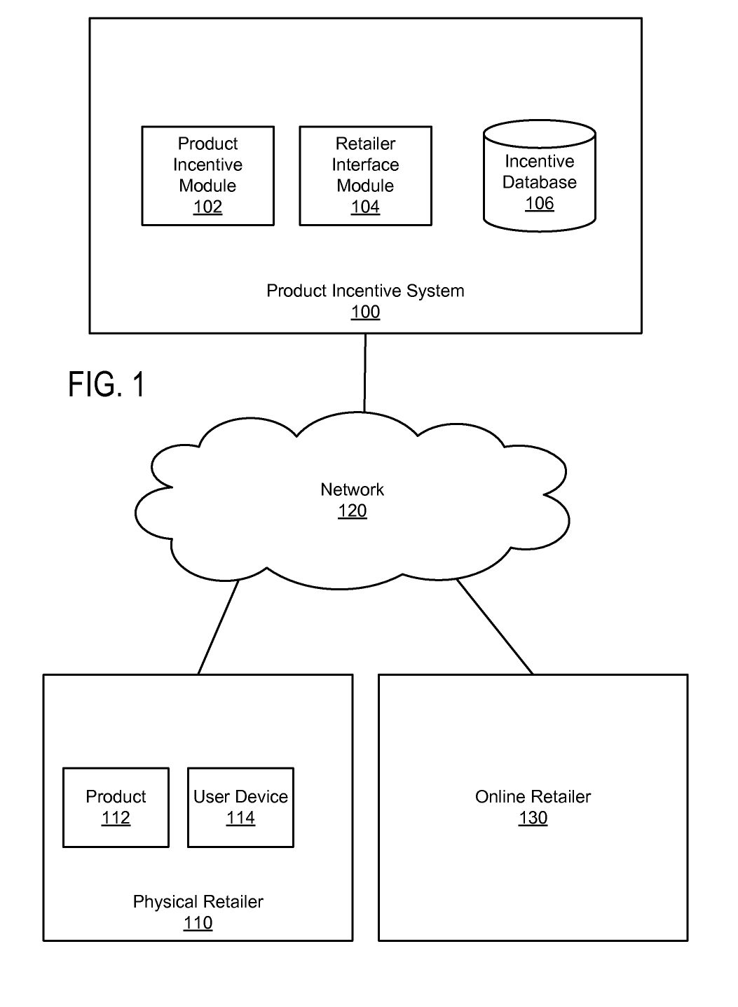

FIG. 1 illustrates one embodiment of an environment for incentivizing purchases at physical retailers. The environment in this embodiment includes a product incentive system 100, a physical retailer 110, an online retailer 130, and a network 120. While only one of each of these entities is shown in FIG. 1, other embodiments may have multiple ones of each entity. Moreover, other embodiments may include different and/or additional entities than those shown in FIG. 1.

Generally, a user within the premises of a physical retailer 110 uses a user device 114 to send a product identifier associated with a product 112 to the product incentive system 100. The product incentive system 100 identifies the product based on the product identifier and solicits bids offering to sell the product from at least one online retailer 130. The product incentive system 100 also interacts with the physical retailer 110 to identify any incentives that the physical retailer offers the user to purchase the product while on the premises of the physical retailer. The product incentive system 100 provides at least one online retailer bid and physical retailer incentive to the user device 114. The user may then view the bid and incentive on the user device 114 and decide whether to purchase the product from the physical retailer 110. As such, the physical retailer 110 is provided with an opportunity to incentivize the user to purchase the product 112 from the physical retailer and thereby improve its conversion rate among shoppers who visit the physical premises of the physical retailer.

In more detail, the physical retailer 110 shown in FIG. 1 represents the premises of a physical retail location operated by the physical retailer 110. The premises are located at a specific geographic location. The physical retailer 110 sells physical products 112 that may be purchased and obtained by shoppers who visit the physical retailer's premises. For example, the physical retailer 110 may be a store having an inventory of products for sale to shoppers who visit the store. One physical retailer 110 may operate multiple stores with premises at different locations.

The product 112 shown in FIG. 1 represents one or more physical products offered by the physical retailer 110. The products 112 sold by the retailer may include, e.g., electronics, furniture, groceries, and clothing. The physical retailer 110 sells the product at a specified price. Typically the price is displayed on a price tag affixed to the product or in proximity to the product. In one embodiment, the price tag or product itself includes a product identifier that uniquely identifies the product (e.g., the make and model of product). For example, the product identifier may be specified by an explicit universal product code (UPC), quick response (QR) code, or international standard book number (ISBN) displayed on the packaging of the product. The product identifier may also be implicitly described by the product itself, such as a name of the product or manufacturer displayed on the packaging of the product, or even an image of the product itself

The user device 114 is used by the user to interact with the product incentive system 100 via the network 120. The user device 114 may be a computing device such as a smartphone, tablet computer, laptop computer, or other similar device that the user carries on his or her person when visiting the physical retailer 110. The user device 114 may also be a desktop computer, kiosk, or other device installed or otherwise located at the physical retailer. The user device 114 executes an application formed of one or more computer program modules enabling the user to interact with the product incentive system 110. The user device 114 may also include additional functionality, such as a location sensor that determines the current geographic location of the device, a camera for sensing optical data, and a radio frequency (RF) sensor for sensing RF data.

In one embodiment, the user uses the user device 114 to send purchase incentive requests to the product incentive system 100 and to view information received in response to such requests. To send a purchase incentive request, the user provides 114 certain information to the device such as a user identifier identifying the user (e.g., authentication credentials), and the product identifier. For example, the user may type the product identifier into the device or capture the identifier through optical or RF sensing. The user device 114 formulates the purchase incentive request and sends it to the product incentive system 100 via the network 120. In one embodiment, a purchase incentive request includes the user identifier, the product identifier, and location information indicating the geographic location of the device 114. The purchase incentive request may also explicitly identify the physical retailer 110. The identity of the physical retailer 110 may also be determined from the product identifier, the location information, and/or other information in the request.

The user device 114 receives information from the product incentive system 110 in response to the purchase incentive requests. This information may include an online retailer bid to sell the identified product and an incentive offered by the physical retailer 110 if the user purchases the product at the physical retailer's premises. The user device 114 presents this information to the user so that the user may evaluate the bid and incentive. The user may use the user device 114 to interact with the product incentive system 100 to negotiate a purchase of the product. For example, the user may accept a bid from the online retailer, purchase the product using the incentive, decline to purchase the product, etc. In one embodiment, the user device 114 may receive and display additional bids and incentives during the negotiation.

The network 120 enables communications between the user device 114, product incentive system 100, and online retailer 130 and in one embodiment is the Internet. In one embodiment, the network 120 uses standard communications technologies and/or protocols.

Thus, the network 120 can include links using technologies such as Ethernet, 802.11, worldwide interoperability for microwave access (WiMAX), 3G, digital subscriber line (DSL), asynchronous transfer mode (ATM), InfiniBand, PCI Express Advanced Switching, etc. Similarly, the networking protocols used on the network 120 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 120 can be represented using technologies and/or formats including the hypertext markup language (HTML), the extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above.

The online retailer 130 is a merchant offering products for sale online via the network 120. For example, the online retailer 130 may operate one or more websites that offer physical products for sale. Shown here as a single online retailer 130, a plurality of online retailers may be present in various embodiments.

In one embodiment, the online retailer 130 interacts with the product incentive system 100 via the network 120 to receive information from purchase incentive requests provided by users of user devices 114. For example, the online retailer 130 may receive a product identifier identifying a product, a user identifier identifying the user contemplating purchasing the product, and the geographic location of the user device 114. In response, the online retailer 130 uses the product identifier to identify the product, and formulates a bid offering to sell the product to the user. A bid may have associated parameters that describe its terms. For example, the bid parameters may include the price at which the online retailer 110 is willing to sell the product to the user, shipping, handling, tax-associated costs, estimated shipping dates, estimated arrival dates, and quantity in stock at the online retailer 130. The online retailer 130 provides the bid and its associated parameters to the product incentive system 100.

The product incentive system 100 receives purchase incentive requests from user devices 114 and provides online retailer bids and physical retailer incentives to the user devices 114 in response to the requests. In one embodiment, the product incentive system 100 includes various modules and databases for enabling its functionality. An incentive database 106 stores information describing incentives offered by one or more physical retailers and other information used by the product incentive module 102. While shown within the product incentive system 100, the incentive database 106 may in fact be located at a remote location or distributed over multiple remote locations. For example, the incentive database 106 may comprise multiple databases maintained by the operator of the product incentive system 100 and/or by multiple physical 110 and/or online retailers 130 connected to the product incentive system via the network 120.

A product incentive module 102 receives a purchase incentive request from a user device 114 and interacts with an incentive database 106 to determines a corresponding physical retailer incentive to provide in response to the request. In addition, the product incentive module 102 coordinates with a retailer interface module 104 that communicates with one or more online retailers 130 to request online retailer bids to provide in response to the request. The product incentive module 102 provides an online retailer bid and physical retailer incentive to the requesting user device 114 in one embodiment.

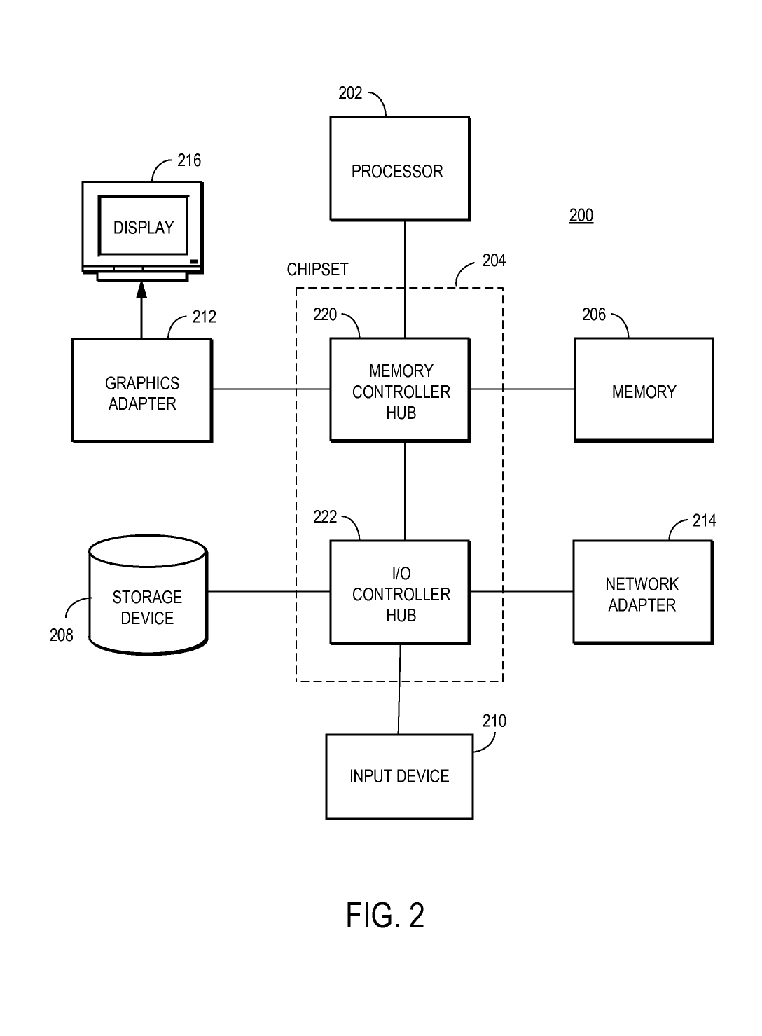

FIG. 2 is a high-level block diagram of a computer 200 for acting as a user device 114, product incentive system 100, or online retailer 130 according to one embodiment. Illustrated are at least one processor 202 coupled to a chipset 204. Also coupled to the chipset 204 are a memory 206, a storage device 208, an input device 210, a graphics adapter 212, and a network adapter 214. A display 216 is coupled to the graphics adapter 212. In one embodiment, the functionality of the chipset 204 is provided by a memory controller hub 220 and an I/O controller hub 222. In another embodiment, the memory 206 is coupled directly to the processor 202 instead of the chipset 204.

The storage device 208 is any non-transitory computer-readable storage medium, such as a hard drive, compact disk read-only memory (CD-ROM), DVD, or a solid-state memory device. The memory 206 holds instructions and data used by the processor 202. The input device 210 may be any device for receiving user input, such as a mouse, track ball, or other type of pointing device; a keyboard; or a touchscreen or other tactile input method. The input device 210 is used to input data into the computer system 200. The graphics adapter 212 displays images and other information on the display 216. The network adapter 214 couples the computer system 200 to a local or wide area network.

As is known in the art, a computer 200 can have different and/or other components than those shown in FIG. 2. In addition, the computer 200 can lack certain illustrated components. For example, a computer 200 acting as a product incentive system 100 may lack an input device 210, graphics adapter 212, and/or display 216. Moreover, the storage device 208 can be local and/or remote from the computer 200 (such as embodied within a storage area network (SAN)).

As is known in the art, the computer 200 is adapted to execute computer program modules for providing functionality described herein. As used herein, the term “module” refers to computer program logic and/or associated hardware components utilized to provide the specified functionality. Thus, a module can be implemented in hardware, firmware, and/or software. In one embodiment, program modules are stored on the storage device 208, loaded into the memory 206, and executed by the processor 202.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

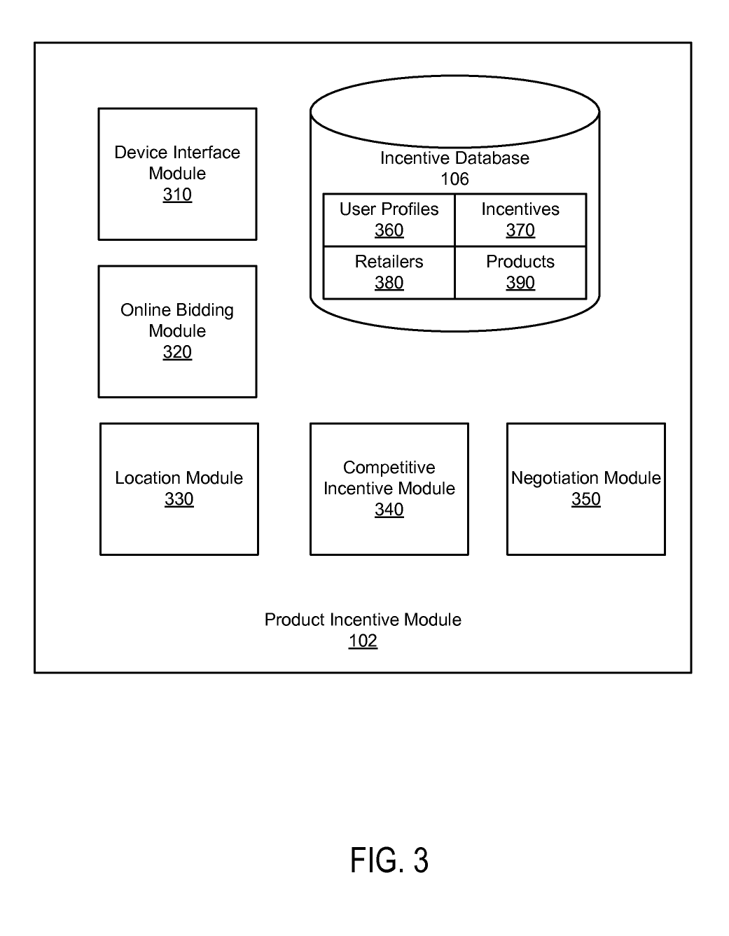

FIG. 3 illustrates the incentive database 106 and various modules within the product incentive module 102 of the product incentive system 100 according to an embodiment. As mentioned above, the incentive database 106 stores information used by the product incentive module 102. In one embodiment, the pricing database 106 includes information describing user profiles 360. The user profiles 360 include account information associated with the users of the user devices 114. This account information may include demographic information, purchase history, payment information, and other details associated with the individual users. The account information may also include information about social networking activity, such as whether the user is linked to a social networking account, or the user's activity in a social network.

Some or all of the information in the user profiles 360 may be absent in some embodiments. The users may be provided with an opportunity to control what types of information are stored in the user profiles 360 In addition, certain user profile data may be treated in one or more ways before it is stored or used, so that personally identifiable information is removed. For example, a user's identity may be treated so that no personally identifiable information can be determined for the user, or a user's geographic location may be generalized, so that a particular location of a user cannot be determined. Thus, the user may have control over how information is collected about the user and used.

The incentive database 106 also stores incentive information 370 describing incentives offered by one or more physical retailers 110. The incentives include promotions, discounts, and other techniques that a physical retailer 110 might offer to entice a user to purchase a product. Many incentives reduce the price of the product below the price displayed on the premises of the physical retailer. In one embodiment, individual physical retailers provide information describing the incentives to the product incentive system 100, which then stores the incentive information in the incentive database 106. The incentives are associated with the individual physical retailer and identify eligible products for the incentive.

The incentives offered by the various physical retailers 110 may vary. The incentives may comprise a price match offering to match a price from an online retailer 130, a specific discount amount, such as $5 or 10% off of a listed price, a discounted or free product that will be provided if the identified product is purchased, such as 50% off a related item, an action for the user to perform to qualify for the incentive, or a combination of these incentives. For example, the action incentive from a physical retailer 110 may require the user to agree to post information about the purchase to a user's social networking account in order to receive a discount on the price of a product.

The incentive information 370 in the incentive database 106 also may include associated qualifying information describing qualifications of users eligible for the incentives. The qualifying information may describe, for example, particular demographics information, purchase histories, types of linked social networking accounts, threshold amounts of activity (e.g., social networking activity), and other information for determining whether a user is eligible for an incentive. The incentive information 370 may also include multiple incentives, with different qualifying information for each of the incentives. For example, a first incentive may provide all users with a 5% discount on the product, and a second incentive may provide a user with a 10% discount provided the user agrees to post information about the purchase to the user's social networking account.

The incentives information 370 may also include instructions for selecting an incentive from among several incentives that may be applicable to a user. Example instructions include instructions for selecting an incentive based on a bid amount from an online retailer 130, and instructions for selecting an incentive based on a user's actions after receiving an incentive. For example, the instructions may specify that if the user declines to purchase the product in response to a first incentive and the user's device provides geographic location information indicating that the user is leaving the premises of the physical retailer 110, the user is offered a different, second incentive.

The retailer information 380 in the incentive database 106 describes the physical 110 and online 130 retailers interacting with the product incentive system 100. For the physical retailers 110, the retailer information 380 include a list of the physical retailers offering incentives to users of user devices 114. In addition, the retailer information 380 describes characteristics of the physical retailers, such as the names of the retailers, geographic locations of the physical premises of the retail locations operated by the retailers, locations of databases or other information maintained by the physical retailers to support the incentives, etc. In some embodiments, the location information further includes information about the location of particular products within the physical premises of the retailers 110.

For the online retailers 130, the retailers information 380 includes a list of the electronic retailers that are bidding on products the users of the user devices 114 are contemplating purchasing. The retailer information 380 also describes characteristics of the online retailers 130, such as the names of the online retailers 130, the locations of databases or interfaces maintained by the online retailers used to solicit bids, and the products and types of products for which the various online retailers will bid.

The products information 390 describes various products for which bids and incentives are provided and associated data for the products. In one embodiment, each product described in the products information 390 includes a reference to the corresponding product identifier for the product that is received from user devices 114, so that a product identifier received from a user device can be correlated with the associated product information in the incentive database 106. In addition, for each product, the products information 390 may describe the supplier (e.g., manufacturer) of the product, retailers (physical and online) carrying the product, a brand of the product, a base price (typically the suggested retail price) and other details. The base price for the product may be associated with each retailer. The base price may also be updated from a retailer database (not shown) to account for price adjustments of the product over time. Each identified product may also be associated with one or more substitute products. In general, a substitute product serves the same general purpose as the identified product. For example, a commoditized product (e.g., a six-foot extension cable) of a particular brand may be associated with a similar commoditized product from another brand.

Turning now to the modules within the product incentive module 102, the device interface module 310 manages communications with the user devices 114. The device interface module 310 receives a purchase incentive request from a user device 114 and identifies the component parts of the request, such as the product identifier, location information, and user identifier. In one embodiment, the device interface module 310 passes the various components of the purchase incentive request to other modules within the product incentive module 102 in order to generate the response to the request. In addition, the device interface module 310 receives the responses to the requests, such as an online retailer bid and a physical retailer incentive, and provides these responses to the requesting user device 114.

The online bidding module 320 receives the product identifier and/or other components of the purchase incentive request from the device interface module 310 and provides one or more online retailer bids in response thereto. In one embodiment, the online bidding module 320 communicates with one or more online retailer 130 through the retailer interface module 104. For example, the online bidding module 320 may use the product identifier in combination with information in the incentive database 106 to identify one or more online retailers 130 that sell the identified product. The online bidding module 320 provides the product identifier and/or other information to the identified online retailers 130. In response, the online bidding module 320 receives online retailer bids from the online retailers 130 having bid parameters describing the terms under which the online retailers will sell the identified product to the user. For example, the bid parameters may indicate a price, shipping and handling costs, estimated ship date, estimated arrival date, and other information about an offer from an online retailer 110.

In one embodiment, the online bidding module 320 selects a subset of the online retailer bids to present to the user of the user device 114. For example, the online bidding module 320 may select a single bid from among multiple bids to present to the user. The online bidding module 320 uses bid selection criteria to select from among the bids based on the bid parameters. The bid selection criteria may vary based on the embodiment, user-specified criteria, and/or other factors. The bid selection criteria may indicate to select a bid based on the price (e.g., select the bid offering to sell the product at the lowest price), the estimated ship date (e.g., select the bid offering to ship the product the soonest), the estimated delivery date (e.g., select the bid offering to deliver the product the soonest), and/or based on other criteria.

Additionally, an embodiment of the online bidding module 320 identifies substitute products related to the product identified in the purchase incentive request and solicits online retailer bids for the substitute products. In another embodiment, the online retailers 130 identify the substitute products, and provide online retailer bids for the substitute products instead of for the identified product. When the identified product is not sold by any online retailers 130, the substitute product may be used to assist a user in meaningfully comparing offers for similar products.

A location module 330 in the product incentive module 102 analyzes location information in purchase incentive requests to determine the user device locations with respect to physical retailers 110. In one embodiment, the location module 330 uses the location information in a request to identify the physical retailer 110 by determining that the specified location corresponds to a location within the premises of the retailer. The location module 330 may also analyze the location information to determine the user device's movement relative to the retailer's premises, such as determining that the user device is entering or exiting the premises. In addition, the location module 330 may use the location information to determine the period of time that the user device 114 is within the premises of the physical retailer 110, and/or near a specific location within the premises, such as the location of the product. The latter time period may be inferred based on a distance from the user device's current location to the device's location when the purchase incentive request was received from the user device 114.

The competitive incentive module 340 identifies physical retailer incentives to provide in response to purchase incentive requests. To respond to a given purchase incentive request, the competitive incentive module 340 determines the physical retailer 110, product, and/or user associated with the request. The competitive incentive module 340 may also access other information in the incentive database 106, such as the user profile for the user 360. In addition, the competitive incentive module 340 may consider the online retailer bids received for the product.

The competitive incentive module 340 uses the determined information to select a responsive incentive from among the incentives described by the incentive information 370 in the incentive database 106. In one embodiment, the competitive incentive module 340 uses the information associated with the incentive request, in combination with the qualifying information associated with the incentives, to identify one or more incentives available to the identified user for purchasing the identified product from the identified physical retailer 110. For example, the competitive incentive module 340 may identify any incentives that match the retailer and product being offered. The competitive incentive module 340 may also identify incentives that are applicable to the user based on information in the requesting user's profile, such as based on the user's demographics, purchase history and/or other user-specific information. If there are multiple incentives available, the competitive incentive module 340 may use incentive selection criteria to select a subset of the incentives (e.g., one or more incentives) for the user. For example, the competitive incentive module 340 may use incentive selection criteria that select the incentive providing the lowest purchase price for the product to the user.

A negotiation module 350 interacts with the users of user devices 114 to negotiate purchase transaction for products. In one embodiment, the device interface module 310 provides an online retailer bid and a physical retailer incentive to a user device 114 in response to a purchase incentives request. The user of the device 114 may use the device to view the bid and incentive and interact with the negotiation module 350 to perform a purchase transaction. Hence, the negotiation module 350 may interact with the user to enable the user to purchase the product 112 from the physical retailer 110 using the incentive or to purchase the product from the online retailer in response to a bid. Of course, the user may also decline to purchase the product. To perform the purchase transaction, the user device may provide payment information or indicate that the negotiation module 350 may use payment information stored in the user profile 360 for the transaction.

When a user declines to purchase the product using the incentive, the negotiation module 350 may continue to negotiate with the user by determining whether to provide an additional incentive to the user. If the user consents, the negotiation module 350 may use the user's location information to determine additional incentives to provide. If the location information indicates that the user is lingering near the physical product 112 on the premises of the physical retailer 110, the negotiation module 350 may provide additional incentives (selected by the competitive incentive module 340) to further entice the user to purchase the product. Likewise, if the location information indicates that the user is exiting the premises of the physical retailer 110, the negotiation module 350 may provide further, more competitive, incentives to the user. For example, when the user is leaving the physical retailer 110, the negotiation module 350 may provide an incentive offering a last-chance best price to the user to encourage the user to purchase the product 112 in person at the physical retailer.

When the user decides to accept the incentive and buy the product provided by the physical retailer, the negotiation module 350 provides a receipt or other proof of payment to the user device 114 for display to the user. The user may use the proof of payment to exit the physical retailer 110 with the product purchased by the user and avoid a check-out register and any associated line at the physical retailer. Alternatively, the negotiation module 350 may provide the user with a coupon, discount code, or other indicia that the user may provide to claim the incentive when purchasing the product at a check-out register at the physical retailer 110.

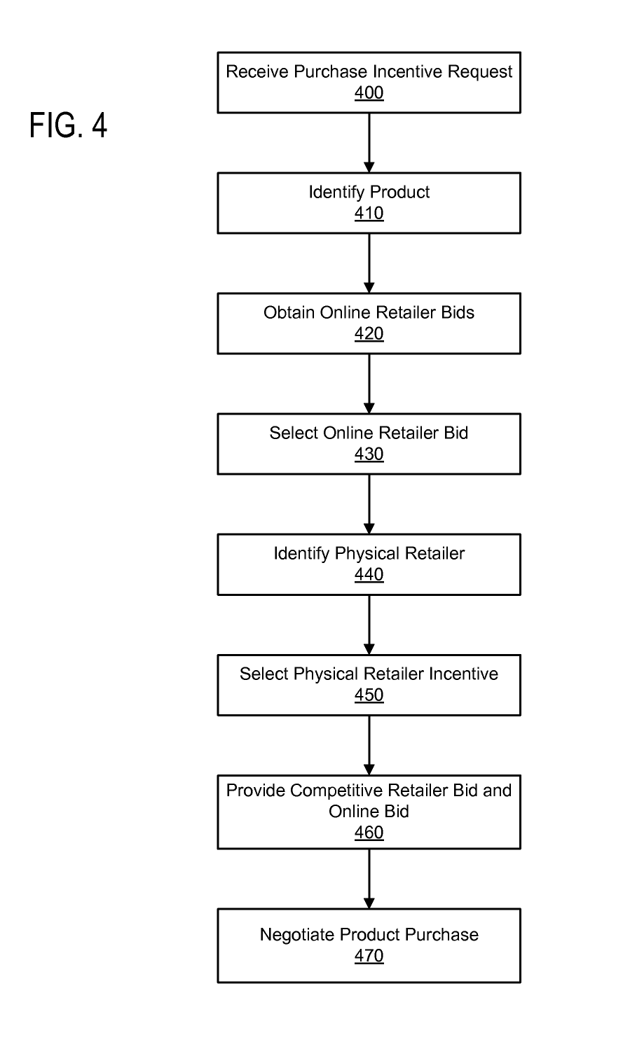

FIG. 4 is a flowchart illustrating a method for incentivizing purchases at physical retailers according to one embodiment. This method is performed in one embodiment by the product incentive module 106. Some or all of the steps of the method may be performed by other entities in other embodiments. In addition, other embodiments may perform different and/or additional steps than the ones described herein. Likewise, the steps may be performed in different orders and in parallel.

As illustrated in FIG. 4, the product incentive module 106 receives 400 a purchase incentive request from a user device 114. For example, the request may be received from a user device 114 used by a user within the premises of a physical retailer 110 who is contemplating purchasing a physical product 112 and therefore requests an incentive for purchasing the product. The purchase incentive request may include a product identifier identifying the product for which the user is requesting an incentive to purchase, location information describing the location of the user device 114, an identifier of the user, and/or other information. The product incentive module 106 identifies 410 the product associated with the product identifier contained in the request. The product incentive module 106 queries online retailers to obtain 420 online retailer bids offering to sell the product to the user. The product incentive module 106 uses selection criteria to select 430 an online retailer bid from among the multiple online retailer bids for the product.

In addition, the product incentive module 106 identifies 440 the physical retailer associated with the purchase incentive request and identifies incentives offered by that retailer for the product. The product incentive module 106 uses qualifying information associated with the incentives to select 450 a physical retailer incentive for the product. The product incentive module 106 provides 460 the selected online retailer bid and the selected physical retailer incentive for the product to the user device 114 in response to the purchase incentive request. The product pricing module 106 then negotiates 470 purchase of the product with the user.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method of incentivizing a purchase at a physical retailer, comprising:
receiving, via a computer network, a purchase incentive request from a user device located on the premises of the physical retailer, the purchase incentive request identifying a product for which an incentive is requested by a user;
obtaining, from at least one online retailer, an online retailer bid offering to sell the identified product to the user;
identifying an incentive for the user to purchase the identified product offered by the physical retailer; and
providing, via the computer network, the online retailer bid and the incentive to the user device.

2. The computer-implemented method of claim 1, wherein obtaining the online retailer bid comprises:
receiving a plurality of online retailer bids offering to sell the identified product to the user from a plurality of online retailers, each online retailer bid having associated bid parameters describing terms of the bid; and
selecting a subset of the plurality of online retailer bids using bid selection criteria and the bid parameters;
wherein the providing provides the selected subset of the online retailer bids to the user device.

3. The computer-implemented method of claim 1, wherein identifying the incentive for the user comprises:
determining information about the user;
identifying a plurality of incentives applicable to the user responsive to the determined information about the user, the product identifier, and the physical retailer; and
selecting a subset of the plurality of incentives applicable to the user using incentive selection criteria, wherein the selected subset of the plurality of incentives includes the identified incentive for the user.

4. The computer-implemented method of claim 1 further comprising negotiating a product purchase for the user using the incentive from the physical retailer.

5. The computer-implemented method of claim 4, wherein the negotiating comprises:
receiving an indication that the user declined to purchase the physical product from the online retailer using the incentive;
responsive to receiving the indication that the user declined to purchase the physical product, receiving location information from the user device indicating movement of the user device; and
determining an additional incentive for the user to purchase the identified product offered by the physical retailer responsive to the received location information; and
providing the additional incentive to the user device.

6. The computer-implemented method of claim 5, wherein the movement of the user device indicates the user device is leaving the premises of the physical retailer.

7. The computer-implemented method of claim 1, wherein obtaining an online retailer bid comprises:
identifying a substitute product related to the identified product; and
obtaining, from at least one online retailer, an online retailer bid offering to sell the substitute product to the user;
wherein the online retailer bid offering to sell the substitute product is provided to the user device.

8. A computer system for providing a social shopping experience, the system comprising:
a non-volatile storage system; and
a processor, the processor configured to:
receive, via a computer network, a purchase incentive request from a user device located on the premises of the physical retailer, the purchase incentive request identifying a product for which an incentive is requested by a user;
obtain, from at least one online retailer, an online retailer bid offering to sell the identified product to the user;
identify an incentive for the user to purchase the identified product offered by the physical retailer; and
provide, via the computer network, the online retailer bid and the incentive to the user device.

9. The computer system of claim 8, wherein to obtain the online retailer bid, the processor is configured to:
receive a plurality of online retailer bids offering to sell the identified product to the user from a plurality of online retailers, each online retailer bid having associated bid parameters describing terms of the bid; and
select a subset of the plurality of online retailer bids using bid selection criteria and the bid parameters;
wherein the providing provides the selected subset of the online retailer bids to the user device.

10. The computer system of claim 8, wherein to identify the incentive for the user, the processor is configured to:
determine information about the user;
identify a plurality of incentives applicable to the user responsive to the determined information about the user, the product identifier, and the physical retailer; and
select a subset of the plurality of incentives applicable to the user using incentive selection criteria, wherein the selected subset of the plurality of incentives includes the identified incentive for the user.

11. The computer system of claim 8, wherein the processor is further configured to negotiate a product purchase for the user using the incentive from the physical retailer.

12. The computer system of claim 11, wherein the negotiating comprises the processor further configured to:
receive an indication that the user declined to purchase the physical product from the online retailer using the incentive;
responsive to receiving the indication that the user declined to purchase the physical product, receive location information from the user device indicating movement of the user device; and
determine an additional incentive for the user to purchase the identified product offered by the physical retailer responsive to the received location information; and
provide the additional incentive to the user device.

13. The computer system of claim 12, wherein the movement of the user device indicates the user device is leaving the premises of the physical retailer.

14. The computer system of claim 8, wherein the obtaining an online retailer bid comprises the processor further configured to:
identify a substitute product related to the identified product; and
obtain, from at least one online retailer, an online retailer bid offering to sell the substitute product to the user;
wherein the online retailer bid offering to sell the substitute product is provided to the user device.

15. A non-transitory computer-readable medium for providing a social shopping experience performed by a user device, the computer-readable medium containing computer program code for implementing the steps of:
receiving, via a computer network, a purchase incentive request from a user device located on the premises of the physical retailer, the purchase incentive request identifying a product for which an incentive is requested by a user;
obtaining, from at least one online retailer, an online retailer bid offering to sell the identified product to the user;
identifying an incentive for the user to purchase the identified product offered by the physical retailer; and
providing, via the computer network, the online retailer bid and the incentive to the user device.

16. The non-transitory computer-readable medium of claim 15, wherein obtaining the online retailer bid comprises:
receiving a plurality of online retailer bids offering to sell the identified product to the user from a plurality of online retailers, each online retailer bid having associated bid parameters describing terms of the bid; and
selecting a subset of the plurality of online retailer bids using bid selection criteria and the bid parameters;
wherein the providing provides the selected subset of the online retailer bids to the user device.

17. The non-transitory computer-readable medium of claim 15, wherein identifying the incentive for the user comprises:
determining information about the user;
identifying a plurality of incentives applicable to the user responsive to the determined information about the user, the product identifier, and the physical retailer; and
selecting a subset of the plurality of incentives applicable to the user using incentive selection criteria, wherein the selected subset of the plurality of incentives includes the identified incentive for the user.

18. The non-transitory computer-readable medium of claim 15 further comprising negotiating a product purchase for the user using the incentive from the physical retailer.

19. The non-transitory computer-readable medium of claim 18, wherein the negotiating comprises:
receiving an indication that the user declined to purchase the physical product from the online retailer using the incentive;
responsive to receiving the indication that the user declined to purchase the physical product, receiving location information from the user device indicating movement of the user device; and
determining an additional incentive for the user to purchase the identified product offered by the physical retailer responsive to the received location information; and
providing the additional incentive to the user device.

20. The non-transitory computer-readable medium of claim 19, wherein the movement of the user device indicates the user device is leaving the premises of the physical retailer.
